(19) United States
(12) Patent Application Publication
(10) Pub. No.: US 2009/0225386 A1
(43) Pub. Date: Sep. 10, 2009

(54) Light beam scanning device

(75) Inventors: Kenichi Hayashi, Nagano (JP); Takeshi Ozawa, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation, Nagano (JP)

(21) Appl. No.: 11/630,523

(22) PCT Filed: Jun. 21, 2005
(86) PCT No.: PCT/JP2005/011312

§ 371 Date: Jun. 9, 2008

(30) Foreign Application Priority Data
Jun. 21, 2004 (JP) 2004-182754

(51) Int. Cl. G02B 26/10

(52) U.S. Cl. 359/209.1

(57) ABSTRACT

The light beam scanning device (1) comprises light source device (2) which emits a light beam, disk-shaped refracting optical element (3) which refracts a light beam emitted from light source device (2), and drive motor (4) which rotationally drives refracting optical element (3). In light beam scanning device (1), when the light beam emitted from light source device (2) is made incident on refracting optical element (3) while having refracting optical element (3) rotated, and the light beam is refracted with refracting optical element (3) and scanned in a predetermined direction. Such light beam scanning device (1) can be downsized even when a light beam scanning is carried out at high resolution.

Moreover, light beam scanning device (1) has superior temperature characteristics and can scan a light beam of stable strength.

### CROSS-REFERENCE TO RELATED APPLICATIONS

This application claims priority of International Application No. PCT/JP2005/011312, filed Jun. 21, 2005 and Japanese Application No. 2004-182754, filed Jun. 21, 2004, the complete disclosures of which are hereby incorporated by reference.

### BACKGROUND OF THE INVENTION

a) Field of the Invention

The present invention relates to a light beam scanning device in which a light beam is scanned in a predetermined direction.

b) Description of the Related Art

Light beam scanning devices are widely utilized for image forming devices such as laser printers, digital copying machines, facsimiles and the like, bar code reading devices, distance between two cars measuring devices and the like. In the light beam scanning device of this type, conventionally a light beam is scanned in a predetermined direction by deflecting with a polygonal mirror the light beam emitted from a light source device (for example, see Japanese Unexamined Patent Publication (Kokai) No. 2003-315720).

However, since the light beam scanning device described in this reference requires large space for installing a polygonal mirror, it becomes an obstacle to downsizing light beam scanning devices.

In order to solve this problem to design a configuration for downsizing a light beam scanning device, proposed is a light beam scanning device equipped with a deflecting disk provided with a function to diffract a light beam emitted from a light source device, and a drive motor which rotationally drives this deflecting disk (for example, see Japanese Unexamined Patent Publication (Kokai) No. H11-231238).

In the light beam scanning device described in this reference, multiple diffraction gratings having different diffraction angles are formed in the circumferential direction of the deflecting disk, and the light beam emitted from a light source device is made incident on the deflecting disk while having the deflecting disk rotated with a drive motor. As a result, the light beam is diffracted at the time of passing through the deflecting disk, and is scanned in a predetermined direction.

### OBJECTS AND SUMMARY OF THE INVENTION

### a) Problems Addressed by the Invention

However, a light beam scanning device which uses a deflecting disk in which a light beam is scanned with a diffraction function has the following problems.

First, there is a problem that, in order to raise resolution of scanning of a light beam, the disk diameter must be enlarged. That is to say, when the light beam scanning range is constant, in order to raise resolution of scanning of the light beam, it is necessary to form many diffraction regions having mutually different diffraction angles along the circumferential direction of the deflecting disk. Moreover, in order to obtain a diffraction effect, multiple grating grooves must be formed in each diffraction range. For instance, let us consider a case in which many diffraction regions having 200 different diffraction efficiencies are formed at equiangular intervals on the deflecting disk in order to scan a certain scanning range in one rotation of the deflecting disk when the light beam scanning range is ±10° and the light beam scanning resolution is 0.1°. In this case, if the wave length of a light beam from a light source device is 800 nm, it is necessary to form a diffraction grating in which the maximum grating groove pitch becomes 0.5 mm. Moreover, in order to gain a diffraction effect, when, for instance, 10 grating grooves are formed in each diffraction region, the width of this diffraction grating becomes 5.0 mm. Therefore, the disk diameter of the portion where the light beam passes through becomes

5.0×200/π=318.3 (mm)

Thus, as the light beam resolution is increased, the disk diameter of the deflecting disk becomes greater; when further downsizing of a light beam scanning device is considered, there is a problem with a light beam scanning device using a deflecting disk that scans a light beam with a diffraction function.

On the other hand, the minimum grating groove pitch becomes 5.1 μm; it is a value of about 3 fold of the step height 1.7 μm in which the primary diffraction efficiency becomes the maximum. Thus, when the step height becomes significant relative to the grating groove pitch, the primary diffraction efficiency declines markedly. Hence there is also a problem that the diffraction efficiency decreases with increasing scanning angle.

Additionally, the diffraction angle and diffraction efficiency at the diffraction grating depend on the incident light wave length, and the diffraction efficiency directly affects transmission. As a result, if variation in the wave length occurs in the light beam emitted from a light source device, the diffraction angle and diffraction efficiency in the diffraction region vary together causing a problem that the strength of the light beam at each scanning angle becomes unstable. Furthermore, if temperature varies, the diffraction efficiency varies because of the refractive index change in the diffraction region; hence there is also a problem that the strength of the light beam at each scanning angle becomes more unstable.

Considering the above-mentioned problems, an object of the present invention is to provide a light beam scanning device which can be downsized even when a light beam scanning is carried out at high resolution.

Moreover, an object of the present invention is to provide a light beam scanning device which has superior temperature characteristics and, in which a light beam of stable strength can be scanned.

### b) Solution to the Problems in Accordance with the Invention

In order to solve the above-mentioned problems, the present invention is characterized by the fact that a light beam scanning device in which a light beam is scanned in a predetermined direction comprises a refracting optical element in which the refraction direction varies depending on the position of the circumferential direction, a light source device which emits a light beam toward said refracting optical element, and a rotationally driving mechanism which rotates the aforementioned refracting optical element to move in the circumferential direction the position of incidence of a light beam on the aforementioned refracting optical element.

In the present invention, a light beam emitted from a light source device is made incident on a disk-shaped refracting optical element while having the refracting optical element rotated with a rotationally driving mechanism. As a result, the light beam is refracted by the refracting optical element and scanned in a predetermined direction. Thus, in the light beam scanning device of the present invention, a light beam is scanned with a refracting function of the refracting optical element. Therefore, for instance, when a great number of inclined faces having mutually different angles of refraction are formed so as to be adjacent in the circumferential direction, a light beam can be scanned within a predetermined scanning range by merely rotating the disk-shaped refracting optical element once. Therefore, it is recommended that inclined faces having one angle of refraction be formed on the refracting optical element in order to emit a light beam at one scanning angle; unlike the case that a deflecting disk equipped with a diffraction function is used, there is no need for installing multiple grating grooves to emit a light beam at one scanning angle. Accordingly, in the present invention, even when the light beam scanning resolution is enhanced, since the refracting optical element diameter can be reduced, downsizing of a light beam scanning device can be carried out.

Moreover, as the angle of refraction and transmission of the refracting optical element are hardly affected by the wave length of the incident light beam, a light beam of stable strength can be scanned. Furthermore, variation in transmission caused by temperature variation in the refracting optical element is small as compared to variation in the diffraction efficiency. As a result, a light beam of stable strength can be scanned with little effect of temperature variation.

In the present invention, it is preferable that the aforementioned refracting optical element allow an incident light beam from the aforementioned light source device to pass through from one end face and emit from the other end face. When it is configured this way, even if rotation blurring or face blurring occurs in the disk-shaped refracting optical element, the angle of refraction hardly changes; hence the light beam scanning jitter characteristics are good. In contrast to this, in a light beam scanning device using a deflecting disk that utilizes a polygonal mirror or diffraction function, rotation blurring or face blurring affects the light beam scanning angle as it is. Hence, in the light beam scanning device of the present invention, the light beam scanning jitter characteristics are improved markedly.

In the present invention, the aforementioned light source device comprises a light-emitting element that emits a light beam, and a lens that changes the divergence angle of a light beam emitted from said light-emitting element; at the same time, it emits a light beam in the direction roughly perpendicular to the rotational plane of the aforementioned refracting optical element.

In the present invention, the aforementioned light source device comprises a light-emitting element that emits a light beam, and a collimator lens that converts a light beam emitted from said light-emitting element to a parallel beam; at the same time, it may adopt a configuration in which a light beam is emitted in the direction parallel to the rotational plane of the aforementioned refracting optical element or in the slanting direction. In this case, with respect to the light beam emitted from the aforementioned light source device, arranged is a mirror which reflects said light beam in the direction roughly perpendicular to the rotational plane of the aforementioned refracting optical element and makes it incident on the aforementioned refracting optical element. When the light source device comprises a collimator lens, a predetermined distance is needed between the light-emitting element and the refracting optical element. Namely, for the adjustment of the light beam size, the distance between the collimator lens and the light-emitting element must be adjusted, and a predetermined distance is needed between the light-emitting element and the refracting optical element. Accordingly, a predetermined distance between the light-emitting element and the refracting optical element can be secured by making a light beam incident on the refracting optical element from the light source device through a mirror. Additionally, when it is configured in such a way that a light beam is emitted in the direction parallel to the rotational plane of the refracting optical element or in the slanting direction, it is possible to thin down a light beam scanning device.

Moreover, in the present specification, “the direction parallel to the rotational plane of the refracting optical element or in the slanting direction” means the direction other than the direction perpendicular to the rotational plane; when a light beam is emitted in this direction, as compared to the case that a light source device is installed in such a way that a light beam is emitted in the direction perpendicular to the rotational plane, a light beam scanning device can be thinned down. Moreover, laser diodes, light-emitting diodes, laser generators and the like can be cited for the light-emitting element.

In the present invention, the aforementioned refracting optical element comprises multiple division regions divided in the circumferential direction, and may adopt a configuration in which an inclined face that refracts an incident light beam in a predetermined direction is formed on each division region. Namely, it is preferable that the refracting optical element be divided into multiple radial division regions in the circumferential direction, and an inclined face that refracts an incident light beam be formed in each of said division regions. When configured in this way, a disk-shaped refracting optical element can be formed with a simple configuration. Moreover, in the present specification, the inclined face shall also contain a face with an angle of inclination of 0°.

In the present invention, in each of the aforementioned multiple division regions, the aforementioned inclined face has a certain angle of inclination; it is preferable that, in the aforementioned multiple division regions aligned in the circumferential direction, the angle of inclination of the aforementioned inclined face be changed continuously. That is to say, preferably the configuration is in such a way that the angle of inclination of the inclined face is constant in each of the division regions, and the angle of inclination of the inclined face increases or decreases in the adjacent division regions.

In the present invention, the aforementioned division regions are preferably divided at approximately equiangular intervals. When configured in this way, it is recommended that a pulse-shaped light beam be emitted at regular intervals from a light source device; then, control of the light source device is easy. Additionally, a light beam can be made incident on the central position in the circumferential direction of the division region by merely emitting a pulse-shaped light beam at regular intervals from a light source device. In this case, since a light beam can be refracted as planned with a refracting optical element, proper light beam scanning can be carried out.

In the present invention, it is preferable that the aforementioned inclined face be formed only on one side of the aforementioned refracting optical element. In this case, it is recommended that the inclined face be configured in such a way that the angle of inclination θw of the aforementioned inclined face with respect to the rotational plane of the aforementioned refracting optical element, the scanning angle θs of a light beam emitted from the aforementioned refracting optical element, and the refractive index n of the aforementioned refracting optical element satisfy the relationship of

sin(θw+θs)=n·sinθw

When the inclined face is formed on only one side of the refracting optical element, processing of the refracting optical element is easy.

In the present invention, it is preferable that an inclined face continuous in the circumferential direction be formed in the aforementioned refracting optical element, and the angle of inclination of said inclined face changes continuously in the circumferential direction. When configured in this way, high resolution scanning can be carried out. In this case as well, the aforementioned inclined face is preferably formed on only one side of the aforementioned refracting optical element. In this case, it is recommended that the inclined face be configured in such a way that the angle of inclination θw of the aforementioned inclined face with respect to the rotational plane of the aforementioned refracting optical element, the scanning angle θs of a light beam emitted from the aforementioned refracting optical element, and the refractive index n of the aforementioned refracting optical element satisfy the relationship of

sin(θw+θs)=n·sinθw

When the inclined face is formed on only one side of the refracting optical element, processing of the refracting optical element is easy.

In the present invention, it is preferable that a refraction preventive treatment be done at least at the end face on the light beam incident side of the aforementioned refracting optical element. When thus configured, the light returning to the light source device, which may cause variations in output of the light source device, can be reduced. Additionally, when a refraction preventive treatment is done, transmission is increased; as a result, a loss of the light quantity from the light source device can be reduced.

In the present invention, the aforementioned refracting optical element can be formed with a resin. Moreover, it can also be formed with glass. When formed with a resin, it has superior productivity, and weight reduction and cost reduction become possible. Moreover, even when formed with a resin, for instance, if the temperature variation is about ±50° C., the change in the scanning angle is small, and there is almost no effect on the scanning performance. On the other hand, when formed with glass, since there is almost no effect of temperature change the temperature characteristics stabilize and, at the same time, even under a high temperature environment, use of the light beam scanning device becomes possible.

In the present invention, for the aforementioned inclined face, either a configuration inclined in the circumferential direction or a configuration inclined in the radial direction may be adopted.

In the present invention, it is preferable that the device be equipped with a means for position detection which detects the rotational position of the aforementioned refracting optical element and, based on the detection result of said position detection means, the rotation of the aforementioned refracting optical element by the aforementioned rotationally driving mechanism and an emission of a light beam from the aforementioned light source device be controlled. When thus configured, based on the rotational position of the refracting optical element, the rotational action of a rotationally driving mechanism and the light-emitting action of a light source device can be feed-back controlled, and synchronization of the light-emitting timing of the light source device and the rotational position of the refracting optical element can be maintained accurately, and appropriate light beam scanning can be performed.

In the present invention, it is preferable that the aforementioned rotationally driving mechanism rotate the aforementioned refracting optical element at a constant rate, and the aforementioned light source device emit a pulse-shaped light beam at regular intervals toward the aforementioned refracting optical element. When thus configured, complicated control such as feed-back control becomes unnecessary simplifying a circuit configuration. For the configuration to make a pulse-shaped light beam incident at regular intervals on the refracting optical element, it is recommended that a pulse-shaped light beam be emitted at regular intervals from a light source device. Additionally, while a light beam is emitted continuously from a light source device, a masking blade may also be installed at some midpoint in the optical path so as to shield this light beam at regular intervals allowing a pulse-shaped light beam to make incident on the refracting optical element at regular intervals.

In the present invention, when a continuous inclined face is formed in the circumferential direction in the aforementioned refracting optical element, and the angle of inclination of said inclined face changes continuously in the circumferential direction, the aforementioned rotationally driving mechanism may be allowed to rotate the aforementioned refracting optical element at a constant rate, and the aforementioned light source device may also emit a light beam continuously toward the aforementioned refracting optical element.

### BRIEF DESCRIPTION OF THE DRAWINGS

In the drawings:

FIG. 1 shows a perspective view of a general configuration of a light beam scanning device of embodiment 1 of the present invention;

FIG. 2 shows a general side view to schematically present a general configuration of the light beam scanning device shown in FIG. 1;

FIG. 3 shows a perspective view to schematically present a general configuration of the refracting optical element used in the light beam scanning device shown in FIG. 1;

FIG. 4 shows a top view of the refracting optical element illustrated in FIG. 3;

FIGS. 5(A), (B) and (C) are respectively the X-Y cross sectional drawing, Y-Y cross sectional drawing and Z-Z cross sectional drawing of FIG. 4;

FIG. 6 is a drawing to describe the case that the inclined face of the refracting optical element illustrated in FIG. 3 and FIG. 4 contains an inclined face with a 0° angle of inclination;

FIG. 7 shows a perspective view to schematically present a general configuration of the refracting optical element used in the light beam scanning device of embodiment 2 of the present invention;

FIG. 8 shows a block diagram of a light beam scanning device of embodiment 3 of the present invention;

FIG. 9 shows a perspective view to schematically present a general configuration of a refracting optical element used for the light beam scanning device shown in FIG. 8;

FIG. 10 shows a top view of the refracting optical element shown in FIG. 9;

FIG. 11 shows a cross sectional drawing to present the W-W cross section of FIG. 9;

FIG. 12 shows a perspective view to schematically present a general configuration of a refracting optical element used in the light beam scanning device of embodiment 4 of the present invention;

FIG. 13 shows a perspective view to schematically present a general configuration of a refracting optical element used in the light beam scanning device of another embodiment of the present invention; and

FIG. 14 shows a perspective view to schematically present a general configuration of a refracting optical element used in the light beam scanning device of another embodiment of the present invention.

### DESCRIPTION OF THE PREFERRED EMBODIMENTS OF THE INVENTION

The best mode for the embodiments of the present invention is described with reference to the drawings as follows:

### Embodiment 1

### a) General Configuration of Light Beam Scanning Device

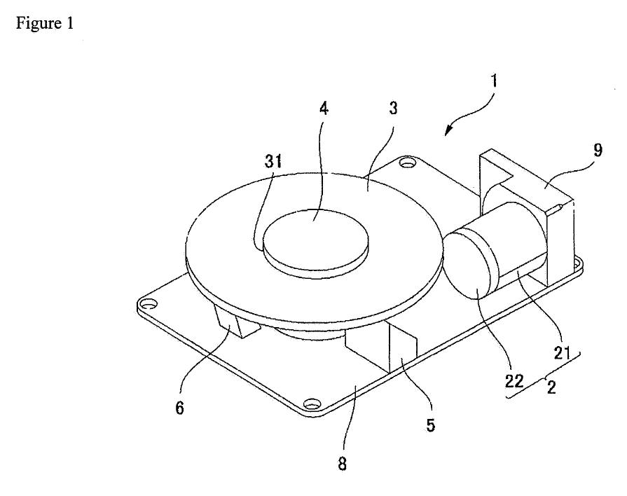

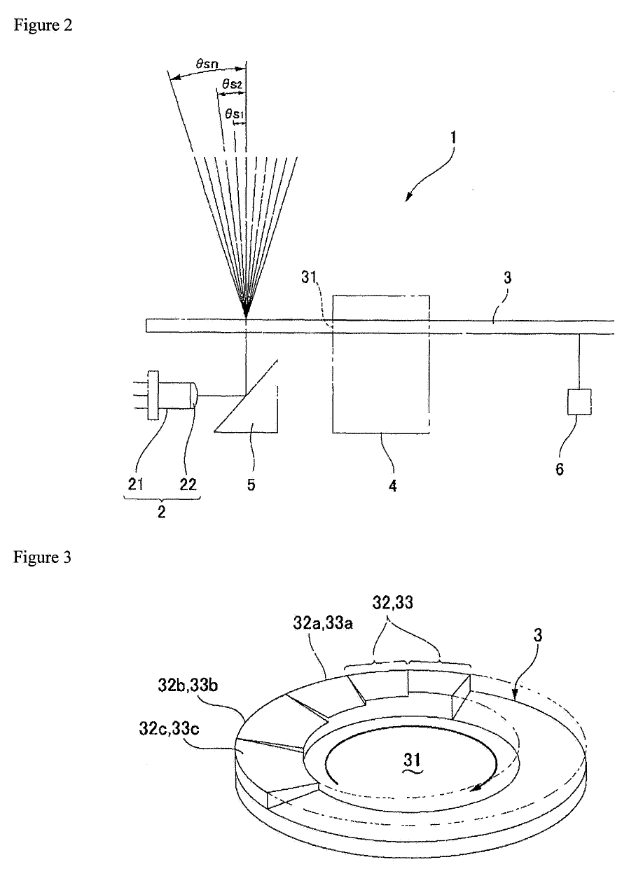

FIG. 1 is a perspective view to show a general configuration of a light beam scanning device of embodiment 1 of the present invention. FIG. 2 is a general side view to show schematically a general configuration of the light beam scanning device shown in FIG. 1.

The light beam scanning device shown in FIG. 1 and FIG. 2 comprises light source device 2 which emits a light beam, disk-shaped refracting optical element 3 which refracts a light beam emitted from light source device 2, drive motor 4 as a rotationally driving mechanism which rotationally drives refracting optical element 3, mirror 5 which raises a light beam emitted from light source device 2 toward refracting optical element 3, and optical encoder 6 as a position detection means which detects the rotational position of refracting optical element 3. In light beam scanning device 1, refracting optical element 3 changes its refracting direction in the circumferential direction as mentioned later. Accordingly, the light beam emitted from light source device 2 is made incident on refracting optical element 3 while having refracting optical element 3 rotated, and the light beam is refracted with refracting optical element 3 and scanned in a predetermined direction. Especially in the present embodiment, it is configured in such a way that the light beam emitted from light source device 2 passes through refracting optical element 3; refracting optical element 3 allows the light beam (from light source device 2) made incident on one end face to pass through and emits it from the other end face. Drive motor 4, mirror 5 and optical encoder 6 are directly installed in frame 8, and light source device 2 is installed in frame 8 through holder 9.

In light source device 2, laser diode 21 as a light-emitting element to emit a light beam, and collimator lens 22 which converts the light beam emitted from laser diode 21 to the parallel light are fully integrated. Emitted from laser diode 21 is, for example, a laser light of 880 nm. As shown in FIG. 2, a light beam is emitted from light source device 2 toward a plane perpendicular to the rotational axis of drive motor 4, in other words, in the direction parallel to the rotational plane of refracting optical element 3.

Mirror 5 raises a light beam emitted from light source device 2 in the axis direction of drive motor 4, and makes the light beam incident on refracting optical element 3 in such a way that the light beam is roughly perpendicular to the rotational plane of refracting optical element 3. Mirror 5 is, for instance, a total reflection mirror, and installed on the emission side of light beam device 2.

Drive motor 4 is installed on the side of mirror 5. Drive motor 4 in the present embodiment is a high speed brushless motor, and configured so as to be able to rotate, for example, at about 10,000 rpm. Drive motor 4 is not limited to a brushless motor; various motors such as the stepping motor and the like can also be used. Moreover, mirror 5 may be omitted and the light beam emitted from light source device 2 may be lead to refracting optical element 3 directly.

Central hole 31 is formed in refracting optical element 3, and this central hole 31 is fixed to the rotator of drive motor 4. Therefore, refracting optical element 3 is configured so as to be rotationally driven around the axial line of drive motor 4 (center of refracting optical element 3). The detail of the refracting optical element 3 configuration is described later

Optical encoder 6 is installed so as to face refracting optical element 3 in the axial direction of drive motor 4. A grating (not shown in the figure) is formed on the face opposite to refracting optical element 3 that faces optical encoder 6. By detecting this grating with optical encoder 6 carried out is a detection of the rotational position of refracting optical element 3. In light beam scanning device 1 of the present embodiment, the rotational movement of drive motor 4 is controlled based on the result of the detection result of optical encoder 6. Moreover, based on the detection result of optical encoder 6, the light emitting action of laser diode 21 is to be controlled. Moreover, for the detection of the angular position of refracting optical element 3, a photocoupler or magnetic sensor may be used in place of optical encoder 6.

### b) Configuration of Refracting Optical Element

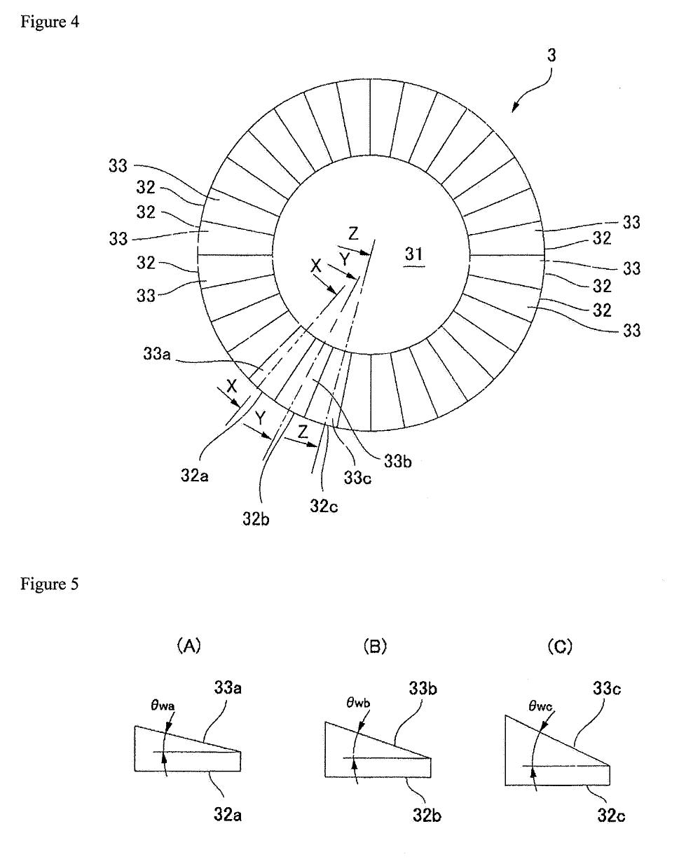

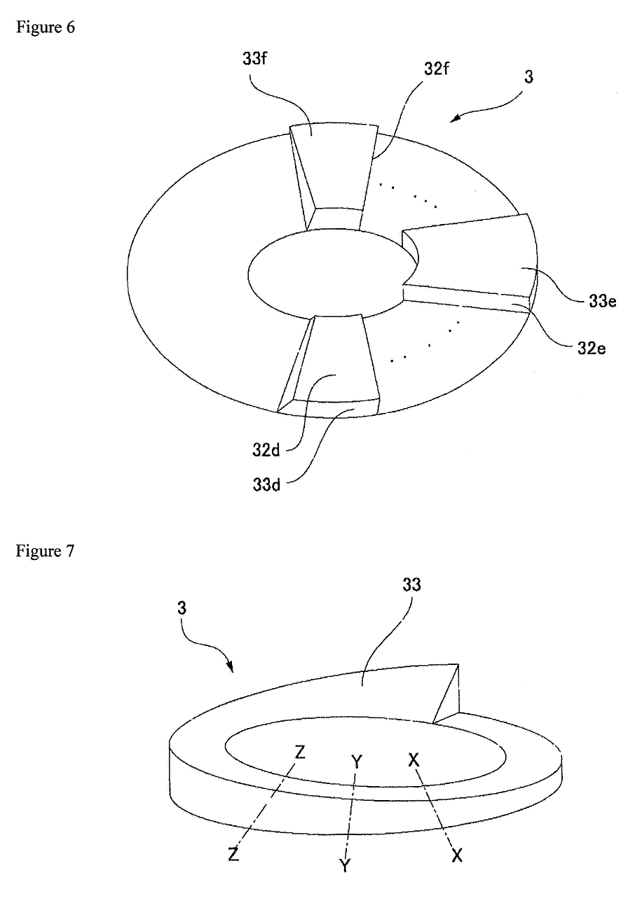

FIG. 3 is a perspective view to show schematically a general configuration of the refracting optical element used in the light beam scanning device shown in FIG. 1. FIG. 4 is a top view of the refracting optical element illustrated in FIG. 3. FIGS. 5(A), (B) and (C) are respectively the X-Y cross sectional drawing, Y-Y cross sectional drawing and Z-Z cross sectional drawing of FIG. 4. FIG. 6 is a drawing to describe the case that the inclined face of the refracting optical element illustrated in FIG. 3 and FIG. 4 contains an inclined face with a θ° angle of inclination.

As shown in FIG. 2, FIG. 3 and FIG. 4, refracting optical element 3 is formed to a flat disk shape having central hole 31 in the center; in the present embodiment, it is formed with a transparent resin. Formed in refracting optical element 3 are multiple radial division regions 32a, 32b, 32c (hereafter called division region 32) which are divided in the circumferential direction with central hole 31 as the center. In the present embodiment, division region 32 is a region divided in the circumferential direction at approximately equiangular intervals with central hole 31 as the center.

The number of division region 32 is determined by the number of scanning points of light beam scanning; in the present embodiment, refracting optical element 3 is made of 201 division region 32. Therefore, for instance, when the light beam scanning is set to be ±10°, the light beam scanning resolution becomes 0.1°. Moreover, for instance, when the diameter of refracting optical element 3 in the position where a light beam passes through is 40 mm, the size of width in the circumferential direction in one division region 32 becomes 0.63 mm. In FIG. 3 and FIG. 4, for convenience in describing, the number of division region 32 is reduced in the drawing.

In each of division region 32, formed so as to be inclined in the radial direction are 33a, 33b, 33c (hereafter called inclined face 33) which refract an incident beam. In the present embodiment, inclined face 33 is formed over the total circumference on only the emission side face (top face in FIGS. 1 and 2) of refracting optical element 3, and the incident side face (bottom face in FIGS. 1 and 2) is formed in the plane shape perpendicular to the axis of drive motor 4. Additionally, inclined face 33 is formed with a certain angle in each of division region 32. Namely, as shown in FIG. 5, the cross section in the radial direction of each of division region 32 is formed in a wedge shape. To be more concrete, the cross section in the radial direction of each of division region 32 is formed in a trapezoid shape parallel to the inner circumferential side and outer circumferential side. Moreover, the angle of inclination of inclined face 33 changes continuously in each of multiple division region 32 which are aligned in the circumferential direction. In inclined face 33 in the present embodiment, as in the case of inclined face 33e of division region 32e shown in FIG. 6, the inclined face with an angle of inclination of 0° is also included.

Moreover, in the present embodiment, when the angle of inclination of inclined face 33 (the angle of inclination of inclined face 3 with respect to the rotational plane of refracting optical element 3) is set to be θw, the scanning angle of the light beam emitted from refracting optical element 3 is set to be θs (see FIG. 2) and the refractive index of refracting optical element is set to be n, inclined face 33 is formed so as to satisfy the relationship of

sin(θw+θs)=n·sinθw

For instance, if n=1.51862, when scanning angle θs is set to be 10°, it is recommended that angle of inclination θw be set to be 18.02°.

Furthermore, in the present embodiment, angle of inclination θw of inclined face 33 of adjacent division region 32 is to increase or decrease gradually. For instance, as shown in FIGS. 5(A˜C), angles of inclination θwa, θwb and θwc of inclined faces 33a, 33b and 33c, respectively, of adjacent division regions 32a, 32b, and 32c, respectively, are to increase gradually.

Additionally, when the total circumference of retracting optical element 3 is observed, as shown in FIG. 6, inclined face 33d of division region 32d inclines toward the inner circumference, and inclined face 33f of division region 32f inclines toward the outer circumference. And, between division region 32d and division 32f, division region 32e whose inclined face 32e has a 0° angle of inclination is present. Namely, when the angle of inclination toward the inner circumference and the angle of inclination toward the outer circumference are set to be a positive angle of inclination and negative angle of inclination, respectively, angle of inclination θw of inclined face 33 decreases gradually, in the circumferential direction, from a positive angle of inclination to a negative angle of inclination; thereafter, when the angle of inclination gradually decreases further to make a round, it is to return to a negative angle of inclination. Moreover, inclined face 33 may also be formed so that a positive angle of inclination and negative angle of inclination repeat in the circumferential direction in such a way that a positive angle of inclination decreases gradually to become a negative angle of inclination, then, conversely, a negative angle of inclination increases gradually to become a positive angle of inclination.

In refracting optical element 3, a reflection preventive treatment is carried out at least on the end face on the light beam incident side. In the present embodiment, a reflection preventive treatment is carried out on the entire face of refracting optical element with a thin film, micro structure or the like.

### c) Production Method for Refracting Optical Element

Refracting optical element 3 of the present embodiment may be produced directly by super-precision processing such as cutting on a transparent resin; or taking production cost into consideration it may also be produced by the use of a mold. The case that refracting optical element 3 is directly cut is described hereinafter. However, the same applies to the case that a mold is cut.

Refracting optical element 3 is subject to cutting work by fly cutting or shaper cutting. Since inclined face 33 in the present embodiment is formed so as to incline in the radial direction, the traveling direction of a blade used in cutting work is set to be the radial direction of refracting optical element 3. To be more concrete, the blade traveling direction is set to be toward the outer circumferential side from the center of refracting optical element 3, or toward the center from the outer circumferential side.

And, as the material of refracting optical element 3 is sent in the axial direction, cutting work is performed to form inclined face 33 of one division region 32. Afterward, refracting optical element 3 is rotated in the circumferential direction to a predetermined angle and, similarly, as the material of refracting optical element 3 is sent in the axial direction, cutting work is performed to form inclined face 33 of adjacent division region 32. Refracting optical element 3 is formed by repeating one round of this action. Sending refracting optical element 3 in the axial direction is set up on NC data, whereby inclined face 33 is formed so that angle of inclination θw of inclined face 33 of adjacent division region 32 increases or decreases gradually.

### d) Light Beam Scanning Method

The light beam scanning method in the light beam scanning device of the present embodiment is described in the following.

First, refracting optical element 3 is driven by drive motor 4 to rotate at a predetermined number of revolutions. Under this state, a light beam is emitted from laser diode 21, and converted to the parallel light with collimator 22. And, the light beam is raised with mirror 5 and made incident so as to be almost perpendicular to the end face on the incident side of refracting optical element 3. To be more specific, the light beam is made incident toward the central position in the circumferential direction of one division region 32.

It is desirable hereon that the effective diameter of the incident light beam on refracting optical element 3 be the width or less in the circumferential direction of one division region 32. However, there is no harm even if the effective diameter of the incident light beam on refracting optical element is the width or more in the circumferential direction of one division region 32, and the incidence is made across multiple division region 32. It is because of the fact that the incident light beam on division region 32 adjacent to division region 32 on which one wishes to make a light beam incident (furthermore, division region 32 adjacent to this division region) is emitted in the direction separated from the light beam that passes through division region 32 on which one wishes to make the light beam incident. Accordingly, even if the effective diameter of the light beam has a width or more in the circumferential direction of one division region 32, it does not become a cause for a noise.

Hereafter, for convenience in describing, the effective diameter of the incident light beam on refracting optical element 3 is set to be the width or less in the circumferential direction of one division region 32.

The incident light beam on division region 32 of refracting optical element 3 is refracted on inclined face 33 when it passes through refracting optical element 3, and is emitted. For instance, as shown in FIG. 2, it is refracted in the direction of scanning angle θs1 at certain division region 32, and is emitted. Hereon, as angle of inclination θw of inclined face 33 of adjacent division region 32 is to increase or decrease gradually, at adjacent division region 32, for instance, it is refracted in the direction of scanning angle θs2, which has an angle difference of 0.1° from scanning angle θs1, and is emitted. Thus, the light beam is emitted successively, for instance, at 0.1° intervals, and scanned in a predetermined scanning range. In this regard, the light beam is emitted without being refracted in division region 32e (See FIG. 6).

In the present embodiment, based on the detection result of the rotational position of refracting optical element 3 with optical encoder 6, the rotational action of drive motor 4 and the light-emitting action of laser diode 21 are to be controlled. Namely, based on the detection result with optical encoder 6, the rotation of drive motor 4 and light-emitting timing of laser diode 21 are controlled so that the light beam emitted from laser diode 21 is made incident toward the central position in the circumferential direction of one division region 32.

### e) Main Effects of the Present Embodiment

As described above, in light beam scanning device 1, while having drive motor 4 rotated, a light beam emitted from light source device 2 is made incident on refracting optical element 3, refracted with refracting light element 3, and scanned in a predetermined direction. That is to say, a light beam is scanned with a refraction function. As a result, when refracting optical element 3 is rotated once by forming in the circumferential direction many inclined faces 33 in which the angles of refraction are mutually different, a predetermined scanning range can be scanned. Namely, it is recommended that, in order to emit a light beam at one scanning angle, one inclined face 33 having angle of refraction θw be formed in refracting optical element 3, and there is no need to install multiple grating grooves to emit a light beam at one scanning angle like a deflecting disk equipped with a diffraction function. Therefore, even when the light beam scanning resolution is raised, the diameter of refracting optical element 3 can be reduced; as a result, downsizing of devices can be done.

Moreover, since refracting optical element 3 is flat and disk-shaped, the device can also be thinned down. In the above-mentioned example, since the width in the circumferential direction of division region 32 at the light beam transmission position is 0.63 mm, it is possible to form inclined face 33 sufficiently.

Moreover, refracting optical element 3 used in the present embodiment utilizes its refractive action, and the angle of refraction is hardly subject to the effect of the incident light beam wave length. Accordingly, in light beam scanning device 1 of the present embodiment, a light beam of stable strength can be scanned. Furthermore, for refracting optical element 3, even if temperature changes the change in transmission caused by temperature changes is small as compared to the change in diffraction efficiency. Therefore, a light beam of stable strength can be scanned with little influence of changes in temperature.

Additionally, in the present embodiment, a light beam emitted from light source device 2 is to pass through refracting optical element 3. As a result, even if rotational blurring or face blurring occurs in refracting optical element 3 rotated with drive motor 4, the angle of refraction hardly changes. Accordingly, a light beam scanning jitter is good.

Furthermore, in the present embodiment, light source device comprises laser diode 21 to emit a light beam, and collimator lens 22. Moreover, a light beam is emitted toward the direction parallel to the rotational plane of refracting optical element 3 and, at the same time, the light beam emitted is raised at the right angle by mirror 5, and made incident on refracting optical element 3 so as to be almost perpendicular to the rotational plane of refracting optical element 3. Hereon, when light source device 2 comprises collimator lens 22, in order to adjust the light beam size, the distance between collimator lens 22 and light-emitting 21 must be adjusted. While a predetermined distance is needed between light-emitting element 21 and refracting optical element 3, since, in the present embodiment, the device is configured in such a way that the light beam emitted from light source is made incident on refracting optical element 3 via mirror 5, a predetermined distance between light-emitting element 21 and refracting optical element 3 can be secured. Moreover, as a light beam is emitted toward the direction parallel to the rotational plane of refracting optical element 3, light beam scanning device 1 can be thinned down.

In the present embodiment, refracting optical element 3 is comprised of multiple radial division region 32 that are divided in the circumferential direction, and inclined face 33 to refract an incident light beam is formed in each of divided region 32. As a result, refracting optical element 3 can be formed with a simple configuration.

Moreover, inclined face 33 with a certain angle is formed in each of division region 32 and, at the same time, angle of inclination θw of inclined face 33 of adjacent division region 32 is to increase or decrease gradually. Accordingly, a light beam can be emitted successively at each scanning angle θs with a simple configuration. Furthermore, division region 32 is a region divided in the circumferential direction at almost equiangular intervals with central hole 31 as the center. As a result, if the number of revolutions of drive motor 4 is constant, since it is recommended that a pulse-shaped light beam be emitted at regular intervals, light source device 2 can be easily controlled.

In the present embodiment, inclined face 33 is formed only on the face on the emission side of refracting optical element 3, and the face on the incidence side is formed in a plane-shape. Accordingly, when a mold is used to produce refracting optical element 3, production of the mold becomes easy as mold die processing on only one face is sufficient. Moreover, when a transparent resin is subjected to direct cutting work to produce refracting optical element 3, since the face on the incidence side is plane-shaped, the material is easily fixed and processing becomes easy.

In the present embodiment, a reflection preventive treatment is carried out on refracting optical element 3. Consequently, the return light to light source device 2 which may cause variations in output of light source device 2 can be reduced. Moreover, as transmission is improved, a loss of quantity of light from light source device 2 can be lowered. As long as the quantity of light required in the host device where light beam scanning device 1 is used can be obtained, there is no need for giving a reflection preventive treatment to refracting optical element 3. In this case, the configuration of refracting optical element 3 can be simplified rendering its production easy.

In the present embodiment, refracting optical element 3 is formed with a resin. Consequently, refracting optical element 3 is superior in productivity, and weight reduction and cost reduction of light beam scanning device 1 are possible. Moreover, even if there is a temperature variation of the order of ±50° C., the coefficient of variation of angle of scanning θs is 1% or less, and there is almost no effect on scanning performance.

In the present embodiment, the rotation of drive motor 4 and light-emission timing of laser diode 21 are controlled so as to make the light beam emitted from laser diode 21 incident toward the central position of the width in the circumferential direction of one division region 32. Accordingly, synchronization of light-emitting timing of laser diode 21 and the rotational position of refracting optical element 3 can be accurately maintained, and appropriate light beam scanning can be performed.

### Embodiment 2

FIG. 7 is a perspective view to show schematically a general configuration of the refracting optical element used in the light beam scanning device of embodiment 2 of the present invention. Since the light beam scanning device and the basic configuration of the refracting optical element of the present embodiment are similar to those of embodiment 1, the same symbols are given to the common parts and their detailed descriptions are omitted.

In refracting optical element 3 of embodiment 1, while multiple division region 32 are formed in the circumferential direction, and inclined face 33 is formed in each of these divided region 32, refracting optical element 3 may also be configured as shown in FIG. 7. In this refracting optical element 3, inclined face 33 continuous in the circumferential direction is formed and, in this inclined face 33, the angle of inclination with respect to the radial direction changes continuously in the circumferential direction.

In thus configured refracting optical element 3, in the same way as FIG. 4, the cross sections of X-X line, Y-Y line and Z-Z line shown in FIG. 7 are represented as shown by FIGS. 5(A), (B) and (C), respectively, and angle of inclination θw in the radial direction is to increase or decrease gradually in the circumferential direction. Consequently, if a light beam is made incident on refracting optical element 3 as refracting optical element is rotated, when the light beam passes through refracting optical element 3, it is refracted on inclined face 33 and scanned. In this case, a laser can be generated continuously to raise the resolution to the maximum limit.

In inclined face 33 of refracting optical element 3, the angle of inclination changes continuously also in the circumferential direction. Because of a small diameter of the incident beam, changes of inclination in this direction can be ignored. Therefore, scanning in the tangential direction of refractive optical element 3 can be ignored.

### Embodiment 3

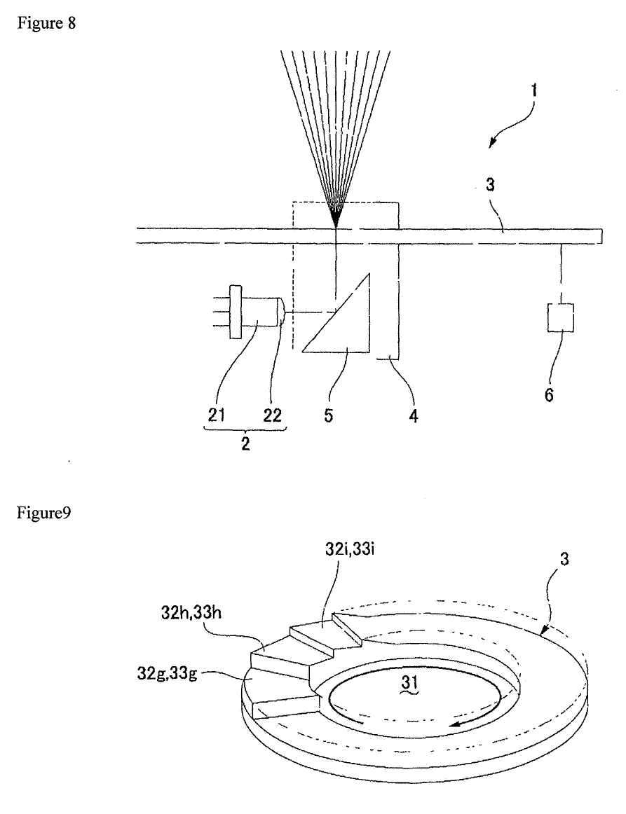

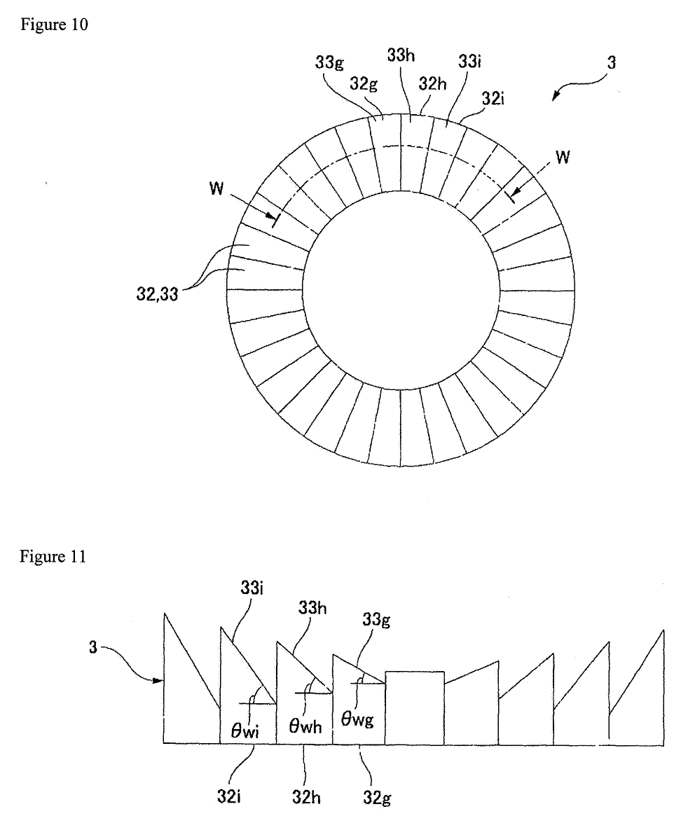

FIG. 8 is a block diagram of a light beam scanning device of embodiment 3 of the present invention. FIG. 9 is a perspective view to show schematically a general configuration of a refracting optical element used for the light beam scanning device shown in FIG. 8. FIG. 10 is a top view of the refracting optical element shown in FIG. 9. FIG. 11 is a cross sectional drawing to show the W-W cross section of FIG. 9. Since, in the present embodiment, this basic configuration is similar to that of the mode of embodiment 1, the same symbols are given to the parts in common and their descriptions are omitted.

While in the above-mentioned embodiment 1 and embodiment 2, inclined face 33 to refract an incident light beam is formed so as to incline in the radial direction, the direction of inclination of inclined face 33 is not limited to the radial direction. For instance, as shown in FIG. 8, FIG. 9, FIG. 10 and FIG. 11, in each of division region 32 that constitutes refracting optical element, inclined face 33 which inclines at a certain angle in the circumferential direction may be formed. In this embodiment as well, inclined face 33 is formed only on the face on the incidence side of refracting optical element 3, and the cross section of each division region 32 becomes wedge-shaped. To be more concrete, the cross section of each division region 32 is formed to a trapezoid shape parallel to the face adjacent to neighboring division region 32. Moreover, in this embodiment as well, inclined face 33 is to contain also a face having a 0° angle of inclination.

In this regard, both the point that, when the angle of inclination of inclined face 33 is set to be θw, the angle of scanning of a light beam emitted from refracting optical element 3 is set to be θs, and the refractive index of refracting optical element 3 is set to be n, inclined face 33 is formed so as to satisfy the following relationship

sin(θw+θs)=n·sin θw,

and the point that, as shown in FIG. 11, angles of inclination θwg, θwh and θwi of inclined faces 33g, 33h and 33i, respectively of adjacent division regions 32g, 32h and 32i, respectively are to increase gradually are also the same as those of the above-mentioned embodiment. Moreover, inclined face 33 may also be inclined face 33 that inclines toward the side opposite to the direction of inclination shown FIG. 11. That is to say, in FIG. 11, inclined face 33 on the left side from the center may also be set to be a left-downward inclined face, and the inclined face on the right side from the center may also be set to be right-downward.

Since, in even thus configured refracting optical element 3, the refracting direction changes in the circumferential direction, when a light beam is made incident on refracting optical element 3 while having refracting optical element 3 rotated, the light beam is refracted on inclined face 33 at the time of passing through refracting optical element 3, and scanned in the tangential direction of refracting optical element 3.

Thus, similar to the above-mentioned embodiments 1 and 2, refracting optical element 3 equipped with inclined face 33 that inclines in the circumferential direction may also be produced by subjecting a transparent resin directly to a super-precision processing such as cutting; or, taking cost into consideration it may be produced by the use of a mold. When refracting optical element 3 or a mold is produced by cutting work, it is recommended that the traveling direction of a blade used for cutting work be set to be in the diameter direction of refracting optical element 3 to form one inclined face 33; at the same time, as the direction of inclination of the blade is changed, refracting optical element 3 be rotated to a predetermined angle to form inclined face 33 of adjacent division region 32.

### Embodiment 4

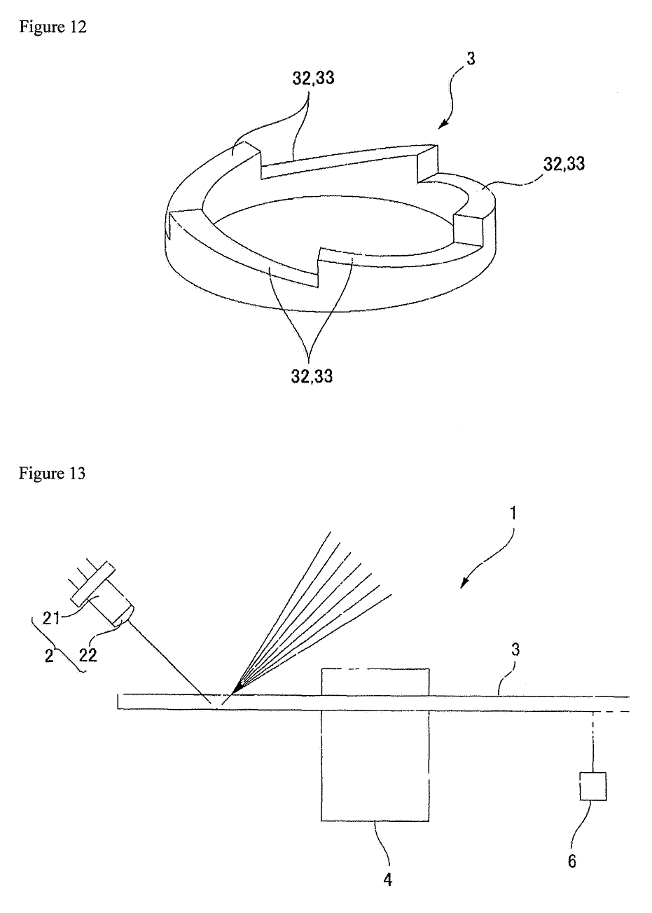

FIG. 12 is a perspective view to show schematically a general configuration of a refracting optical element used in the light beam scanning device of embodiment 4 of the present invention. Since the light beam scanning device and the basic configuration of the refracting optical element of the present embodiment are similar to those of embodiment 3, the same symbols are given to the portions in common and their descriptions are omitted.

In refracting optical element 3 of embodiment 3, multiple division region 32 are formed in the circumferential direction, and in each of these division region 32 formed is inclined face 33 in which angle of inclination θw is constant in every division region, whereas in the present embodiment of embodiment, as shown in FIG. 12, multiple division region 32 are formed in the circumferential direction, and in each of these division region 32 formed is inclined face 33 in which angle of inclination θw in the circumferential direction changes continuously in the circumferential direction. The shape of this shape becomes a quadratic function in the tangential direction, and the slope represented by a primary differential is to change continuously in the tangential direction. Even in a light beam scanning device using thus configured refracting optical element 3, the incident light beam on refracting optical element 3 is refracted on inclined face 33 at the time of passing through refracting optical element 3, and is to be scanned in the tangential direction of refracting optical element 3. While FIG. 12 is an example in which inclined face 33 inclines to only one side, it may be a U shape of a parabola, or it may be a sine curve.

### Other Embodiments

While the above-mentioned embodiments are suitable examples of the best mode of the present invention, the invention is not limited to these examples, and can be changed variously as long as the gist of the present invention is not altered.

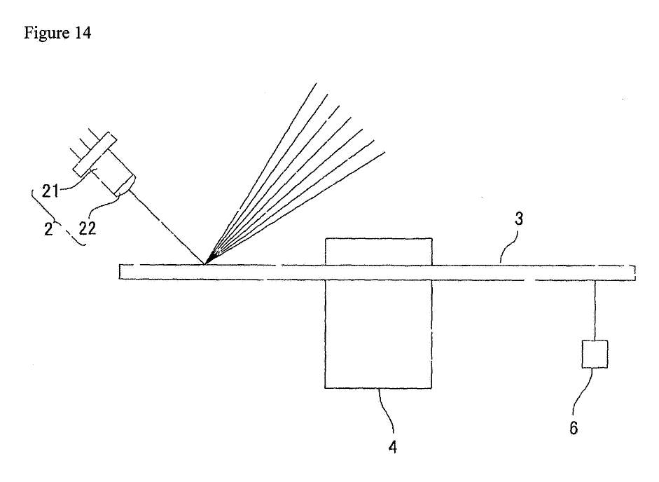

For example, in the above-mentioned embodiment, a light beam emitted from light source device 2 is configured so as to pass through refracting optical element 3. Like the light beam scanning device 1 shown in FIG. 13, after the light beam emitted from light source device 2 is made incident from the top face of refracting optical element 3, it is reflected from the bottom face; afterward, it is emitted from the top face. Hereon, as the direction of refraction is changed in the circumferential direction on the top face of refracting optical element 3, the light beam is refracted in a predetermined direction on the top face and scanned. In this case, as shown in FIG. 13, the light beam is made incident on refracting optical element 3 from the half upper part. Moreover, in this case, mirror 5 becomes unnecessary and, at this point, the configuration of light beam scanning device 1 can be simplified.

Moreover, in above-mentioned embodiments 1-4, inclined face 33 is formed only on the face on the emission side of refracting optical element 3 (top face in FIG. 1 and FIG. 8), but it may be formed only on the face on the incidence side. Additionally, the inclined face may be formed on both faces on the emission side and the incidence side. In the case that the inclined face is formed on both faces, for example, it is recommended that the angle of inclination of the face on the incidence side be made the same in all division region 32.

Furthermore, while, in the above-mentioned embodiment, refracting optical element 3 is formed with a resin, refracting optical element 3 may also be formed with glass. In this case, since it is hardly subject to temperature changes, temperature characteristics are stabilized and, at the same, even under a high temperature environment, the light beam scanning device can be used.

Furthermore, inclined face 33 does not necessarily have to be formed across the entire circumference of the face on the incidence side of refracting optical element 3, and a flat plane may be formed on part of the face on the incidence side.

Moreover, in place of optical encoder 6, the Hall element or MR element set up inside drive motor 4 may be utilized as a position detection means. In this case, it is recommended that pulses be made from a drive magnet which drive motor 4 has, or a magnet for generation of pulses, and additionally from the counter electromotive force, and based on these pulses light-emitting timing of laser diode 21 be controlled so that the light beam emitted from laser diode 21 is made incident toward the central position in the circumferential direction of one division region 32.

Furthermore, the light beam scanning device does not have to be provided with a position detection means. When, like the above-mentioned embodiments 1-4, refracting optical element 3 is comprised of multiple division region 32 divided at approximately equiangular intervals in the circumferential direction, or when a continuous inclined face is formed in the circumferential direction, appropriate light beam scanning can be carried out if drive motor 4 is controlled so as to rotate at a constant rate, and a pulse-shaped light beam is emitted from light source device 2 at regular intervals.

Furthermore, it may also be configured in such a way that without installing mirrors a light beam is emitted from light source device 2 toward the rotational plane of refracting optical element 3, and is made incident directly on refracting optical element 3. Moreover, when mirror 5 is installed, it may also be configured in such a way that light source device is arranged half downward from refracting optical element 3, and a light beam is made incident on refracting optical element 3 from the slanting bottom part of refracting optical element 3.

Moreover, while, in the above-mentioned embodiment, it is configured so that a light beam emitted from light source device 2 passes through refracting optical element 3, it may also be configured so that the light beam emitted from light source device 2 is reflected by refracting optical element 3 like the light beam scanning device shown in FIG. 14. That is to say, since the light beam emitted from light source device 2 is reflected from the top face of refracting optical element 3 but, on the top face of refracting optical element 3, the direction of reflection changes in the circumferential direction, the light beam is scanned in a predetermined direction. In this case, as shown in FIG. 14, the light beam is made incident on refracting optical element 3 from the slanting top part of refracting optical element 3. Moreover, in this case, mirror 5 becomes unnecessary and, at this point, the configuration of light beam scanning device 1 can be simplified.

### INDUSTRIAL AVAILABILITY

In the light beam scanning device of the present invention, a light beam is scanned by a refraction function. Therefore, for example, if a disk-shaped refracting optical element is rotated once by forming in a refracting optical element many inclined faces (in which the angles of refraction are different from one another) so that they become adjacent in the circumferential direction, a predetermined scanning range can be scanned. Namely, it is recommended that inclined faces having one angle of refraction be formed in the refracting optical element in order to make a light beam incident at one scanning angle, and there is no need to set up multiple grating grooves in order to emit a light beam at one scanning angle like a deflecting disk provided with a diffraction function. Accordingly, since, even when light beam scanning is carried out with high resolution, the diameter of the refracting optical element can be reduced, a light beam scanning device can be downsized.

Moreover, the refractive index angle and transmission are hardly subject to the effect of the incident light beam wavelength. Therefore, when a refracting optical element is used, a light beam of stable strength can be scanned. Furthermore, the variation in refractive index caused by temperature changes in the refracting optical element is small, and the temperature characteristics of a light beam scanning device can be improved.

While the foregoing description and drawings represent the present invention, it will be obvious to those skilled in the art that various changes may be made therein without departing from the true spirit and scope of the present invention.

### DESCRIPTION OF REFERENCE SYMBOLS

1 Light beam scanning device
2 Light source device
3 Refracting optical element
4 Drive motor (Rotationally driving mechanism)
5 Mirror
6 Optical encoder
21 Laser diode (Light-emitting element)
22 Collimator lens
32 Division region
33 Inclined face

1-19. (canceled)

20. A light beam scanning device in which a light beam is scanned in a predetermined direction comprising:
a refracting optical element in which the refraction direction varies depending on the position of the circumferential direction;
a light source device which emits a light beam toward said refracting optical element; and
a rotationally driving mechanism which rotates said refracting optical element to move in the circumferential direction the position of incidence of a light beam on said refracting optical element.

21. The light beam scanning device as set forth in claim 20 wherein said refracting optical element allows an incident light beam from said light source device to pass through from one end face and emit from the other end face.

22. The light beam scanning device as set forth in claim 21 wherein said light source device comprises a light-emitting element that emits a light beam, and a lens that changes the divergence angle of a light beam emitted from said light-emitting element; at the same time, it emits a light beam in the direction roughly perpendicular to the rotational plane of said refracting optical element.

23. The light beam scanning device as set forth in claim 21 wherein said light source device comprises a light-emitting element that emits a light beam, and a collimator lens that converts a light beam emitted from said light-emitting element to a parallel beam; at the same time, said light source device adopts a configuration in which a light beam is emitted in the direction parallel to the rotational plane of said refracting optical element or in the slanting direction; wherein, with respect to said light beam emitted from said light source device, arranged is a mirror which reflects said light beam in the direction roughly perpendicular to the rotational plane of said refracting optical element and makes said light beam incident on said refracting optical element.

24. The light beam scanning device as set forth in claim 21 wherein said refracting optical element comprises multiple division regions divided in the circumferential direction, and adopts a configuration in which an inclined face that refracts an incident light beam in a predetermined direction is formed on each division region.

25. The light beam scanning device as set forth in claim 24 wherein, in each of said multiple division regions, said inclined face has a certain angle of inclination; in said multiple division regions aligned in the circumferential direction, the angle of inclination of said inclined face be changed continuously.

26. The light beam scanning device as set forth in claim 24 wherein said division regions are divided at approximately equiangular intervals.

27. The light beam scanning device as set forth in claim 26 wherein a light beam can be made incident on the central position in the circumferential direction of said division region by emitting a light beam at regular intervals from a light source device.

28. The light beam scanning device as set forth in claim 24 wherein said inclined face be formed only on one side of said refracting optical element wherein the inclined face be configured in such a way that the angle of inclination θw of said inclined face with respect to the rotational plane of said refracting optical element, the scanning angle θs of a light beam emitted from said refracting optical element, and the refractive index n of said refracting optical element satisfy the relationship of
sin(θw+θs)=n·sin θw

29. The light beam scanning device as set forth in claim 21 wherein an inclined face continuous in the circumferential direction be formed in said refracting optical element, and the angle of inclination of said inclined face changes continuously in the circumferential direction.

30. The light beam scanning device as set forth in claim 29 wherein said inclined face is formed on only one side of said refracting optical element, wherein said inclined face be configured in such a way that the angle of inclination θw of said inclined face with respect to the rotational plane of said refracting optical element, the scanning angle θs of a light beam emitted from said refracting optical element, and the refractive index n of said refracting optical element satisfy the relationship of
sin(θw+θs)=n·sin θw

31. The light beam scanning device as set forth in claim 21 wherein a refraction preventive treatment be done at least at the end face on the light beam incident side of said refracting optical element.

32. The light beam scanning device as set forth in claim 21 wherein said refracting optical element can be formed with a resin.

33. The light beam scanning device as set forth in claim 21 wherein said refracting optical element is formed with glass.

34. The light beam scanning device as set forth in claim 24 wherein said inclined face is configured in the circumferential direction.

35. The light beam scanning device as set forth in claim 24 wherein said inclined face is configured in the radial direction.

36. The light beam scanning device as set forth in claim 20 wherein said device be equipped with a means for position detection which detects the rotational position of said refracting optical element and, based on the detection result of said position detection means, the rotation of said refracting optical element by said rotationally driving mechanism and an emission of a light beam from said light source device be controlled.

37. The light beam scanning device as set forth in claim 26 wherein said rotationally driving mechanism rotate said refracting optical element at a constant rate, and said light source device emit a pulse-shaped light beam at regular intervals toward said refracting optical element.

38. The light beam scanning device as set forth in claim 29 wherein said rotationally driving mechanism is allowed to rotate said refracting optical element at a constant rate, and said light source device emits a light beam continuously toward said refracting optical element.

39. The light beam scanning device as set forth in claim 29 wherein said inclined face is configured in the circumferential direction.

40. The light beam scanning device as set forth in claim 29 wherein said inclined face is configured in the radial direction.

41. The light beam scanning device as set forth in claim 29 said rotationally driving mechanism rotate said refracting optical element at a constant rate, and said light source device emit a pulse-shaped light beam at regular intervals toward said refracting optical element.
